(19) United States
(12) Patent Application Publication
(10) Pub. No.: US 2025/0212221 A1
(43) Pub. Date: Jun. 26, 2025

(54) APPARATUS AND METHOD THEREOF IN WIRELESS COMMUNICATION SYSTEM

(71) Applicant: Samsung Electronics Co., Ltd., Gyeonggi-do (KR)

(72) Inventors: Sa ZHANG, Beijing (CN); Min WU, Beijing (CN); Feifei SUN, Beijing (CN)

(21) Appl. No.: 18/852,065

(22) PCT Filed: Mar. 31, 2023
(86) PCT No.: PCT/KR2023/004384

§ 371 Date: Sep. 27, 2024

(30) Foreign Application Priority Data
Mar. 31, 2022 (CN) 202210345709.X
Apr. 14, 2022 (CN) 202210394057.9
Jul. 26, 2022 (CN) 202210883795.X
Feb. 16, 2023 (CN) 202310141398.X

(51) Int. Cl. H04W 72/23; H04W 72/21

(52) U.S. Cl. CPC H04W 72/23; H04W 72/21

(57) ABSTRACT

The disclosure relates to a 5G or 6G communication system for supporting a higher data transmission rate. Disclosed in an apparatus and a method thereof in a wireless communication system are provided. The method may include determining a mode of a terminal and/or a base station, and performing at least one of transmitting an uplink channel, receiving a downlink channel, not transmitting an uplink channel, or not receiving a downlink channel based on the determined mode.

### TECHNICAL FIELD

The disclosure generally relates to the field of wireless communication, and in particular, to an apparatus and a method thereof in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide an apparatus and a method thereof in a wireless communication system.

### Solution to Problem

According to an embodiment of the disclosure, a method performed by a terminal in a wireless communication system is provided. The method includes: determining a mode of the terminal and/or a base station; and performing at least one of transmitting an uplink channel, receiving a downlink channel, not transmitting an uplink channel, or not receiving a downlink channel based on the determined mode.

According to an embodiment of the disclosure, determining of the mode of the terminal and/or the base station includes: receiving configuration information, wherein the configuration information is used to indicate at least one of: one or more modes, durations, periodicities, starting times, cells (e.g., cell identifications), bandwidth parts (BWPs) (e.g., BWP indexes), channels (e.g., channel identifications), or timers; determining the mode of the terminal and/or the base station based on the configuration information.

According to an embodiment of the disclosure, determining of the mode of the terminal and/or the base station includes: receiving first configuration information on the mode of the terminal and/or the base station and/or second configuration information on a timer associated with the mode; and determining the mode of the terminal and/or the base station based on the first configuration information and/or the second configuration information.

According to an embodiment of the disclosure, the first configuration information or the second configuration information may be received through higher layer signaling (e.g., a radio resource control (RRC) message) and/or a downlink control information (DCI) message. The first configuration information or the second configuration information may be received through a separate message. Or, the first configuration information and the second configuration information may be received through a single message (e.g., RRC message).

According to an embodiment of the disclosure, in case that the first configuration information is received, the mode of the terminal and/or the base station may be determined based on the first configuration information.

According to an embodiment of the disclosure, in case that the second configuration information is received, the mode of the terminal and/or the base station may be determined based on a state of the timer indicated by the second configuration information. For example, in case that the timer is running, a mode corresponding to the timer may be enabled, and the mode of the terminal and/or the base station may be determined to be the mode corresponding to the timer. For example, in case that the timer is not running, another mode different from the mode corresponding to the timer may be enabled, and the mode of the terminal and/or the base station may be determined to be another mode.

According to an embodiment of the disclosure, the mode includes one or more of: a first mode in which one or more uplink channels are transmitted and/or one or more downlink channels are received, a second mode in which at least one of the one or more uplink channels is not transmitted and/or at least one of the one or more downlink channels is not received, a third mode which is determined as the first mode or the second mode based on signaling, a fourth mode in which the one or more uplink channels are not transmitted and/or the one or more downlink channels are not received, or a fifth mode in which a predefined uplink channel of the one or more uplink channels is not transmitted and/or a predefined downlink channel of the one or more downlink channels is not received.

In some implementations, for example, the mode is configured for a cell and/or a bandwidth part and/or a channel.

According to an embodiment of the disclosure, the method further includes: based on receiving predefined downlink signaling and/or transmitting predefined uplink signaling, changing from a current mode to another mode, or maintaining the current mode.

According to an embodiment of the disclosure, the predefined downlink signaling includes at least one of: a predefined downlink control information (DCI) format; a DCI format scheduling a physical downlink shared channel (PDSCH) and/or a physical uplink shared channel (PUSCH); a specific group common DCI format; or downlink signaling indicating a change from one of the first mode, the second mode, the third mode, the fourth mode and the fifth mode to another of the first mode, the second mode, the third mode, the fourth mode and the fifth mode.

According to an embodiment of the disclosure, the predefined uplink signaling includes at least one of: a scheduling request (SR); a configured grant (CG) physical uplink shared channel (PUSCH); a specific PUCCH; or uplink signaling indicating a change from one of the first mode, the second mode, the third mode, the fourth mode and the fifth mode to another of the first mode, the second mode, the third mode, the fourth mode and the fifth mode.

According to an embodiment of the disclosure, a method performed by a base station in a wireless communication system is provided. The method includes: transmitting configuration information, wherein the configuration information is used to indicate at least one of: one or more modes, durations, periodicities, starting times, cells (e.g., cell identifications), bandwidth parts (BWPs) (e.g., BWP indexes), channels (e.g., channel identifications), or timers; performing at least one of transmitting a downlink channel, receiving an uplink channel, not transmitting a downlink channel, or not receiving an uplink channel.

According to an embodiment of the disclosure, the mode includes one or more of: a first mode in which one or more uplink channels are transmitted and/or one or more downlink channels are received, a second mode in which at least one of the one or more uplink channels is not transmitted and/or at least one of the one or more downlink channels is not received, a third mode which is determined as the first mode or the second mode based on signaling, a fourth mode in which the one or more uplink channels are not transmitted and/or the one or more downlink channels are not received, or a fifth mode in which a predefined uplink channel of the one or more uplink channels is not transmitted and/or a predefined downlink channel of the one or more downlink channels is not received.

According to an embodiment of the disclosure, mode is configured for a cell and/or a bandwidth part and/or a channel.

According to an embodiment of the disclosure, the method further includes: based on transmitting predefined downlink signaling and/or receiving predefined uplink signaling, changing from a current mode to another mode, or maintaining the current mode.

According to an embodiment of the disclosure, the predefined downlink signaling includes at least one of: a predefined downlink control information (DCI) format; a DCI format scheduling a physical downlink shared channel (PDSCH) and/or a physical uplink shared channel (PUSCH); a specific group common DCI format; or downlink signaling indicating a change from one of the first mode, the second mode, the third mode, the fourth mode and the fifth mode to another of the first mode, the second mode, the third mode, the fourth mode and the fifth mode.

According to an embodiment of the disclosure, the predefined uplink signaling includes at least one of: a scheduling request (SR); a configured grant (CG) physical uplink shared channel (PUSCH); a specific PUCCH; uplink signaling indicating a change from one of the first mode, the second mode, the third mode, the fourth mode and the fifth mode to another of the first mode, the second mode, the third mode, the fourth mode and the fifth mode.

According to an embodiment of the disclosure, a terminal in a wireless communication system is also provided. The terminal includes a transceiver configured to transmit and receive signals; and a controller coupled to the transceiver and configured to perform one or more of operations in the above-described methods performed by the terminal.

According to an embodiment of the disclosure, a base station in a wireless communication system is also provided. The base station includes a transceiver configured to transmit and receive signals; and a controller coupled to the transceiver and configured to perform one or more of operations in the above-described methods performed by the base station.

According to an embodiment of the disclosure, a computer-readable storage medium storing one or more computer programs stored thereon is also provided, wherein the one or more computer programs, when executed by one or more processors, may implement any of the above-described methods.

### Advantageous Effects of Invention

The disclosure may provide an apparatus and a method thereof in a wireless communication system.

The disclosure may ensure the network performance while save the energy consumption of network devices.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a schematic diagram of an example wireless network according to an embodiment of the disclosure;

FIG. 2A illustrates an example wireless transmission path according to an embodiment of the disclosure;

FIG. 2B illustrates an example wireless reception path according to an embodiment of the disclosure;

FIG. 3A illustrates an example user equipment (UE) according to an embodiment of the disclosure;

FIG. 3B illustrates an example gNB according to an embodiment of the disclosure;

FIG. 4 illustrates a block diagram of a second transceiving node according to an embodiment of the disclosure;

FIG. 5 illustrates a flowchart of a method performed by a UE according to an embodiment of the disclosure;

FIG. 6A illustrates an some example of uplink transmission timing according to an embodiment of the disclosure;

FIG. 6B illustrates an example of uplink transmission timing according to an embodiment of the disclosure;

FIG. 6C illustrates an example of uplink transmission timing according to an embodiment of the disclosure;

FIG. 7A illustrates a schematic diagram of mode configuration according to an embodiment of the disclosure;

FIG. 7B illustrates a schematic diagram of mode configuration according to an embodiment of the disclosure;

FIG. 7C illustrates a schematic diagram of mode configuration according to an embodiment of the disclosure;

FIG. 7D illustrates a schematic diagram of mode configuration according to an embodiment of the disclosure;

FIG. 8 illustrates a flowchart of a method performed by a terminal according to an embodiment of the disclosure;

FIG. 9 illustrates a block diagram of a first transceiving node according to an embodiment of the disclosure;

FIG. 10 illustrates a flowchart of a method performed by a base station according to an embodiment of the disclosure; and

FIG. 11 illustrates a flowchart of a method performed by a base station according to an embodiment of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the disclosure. For example, unless otherwise defined, the technical terms or scientific terms used in the disclosure shall have the ordinary meaning understood by those with ordinary skills in the art to which the disclosure belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than” or “less than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the disclosure can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the disclosure can be applied to future-oriented communication technologies. In addition, the technical schemes of the embodiments of the disclosure can be applied to future-oriented communication technologies.

Hereinafter, the embodiments of the disclosure will be described in detail with reference to the accompanying drawings. It should be noted that the same reference numerals in different drawings will be used to refer to the same elements already described.

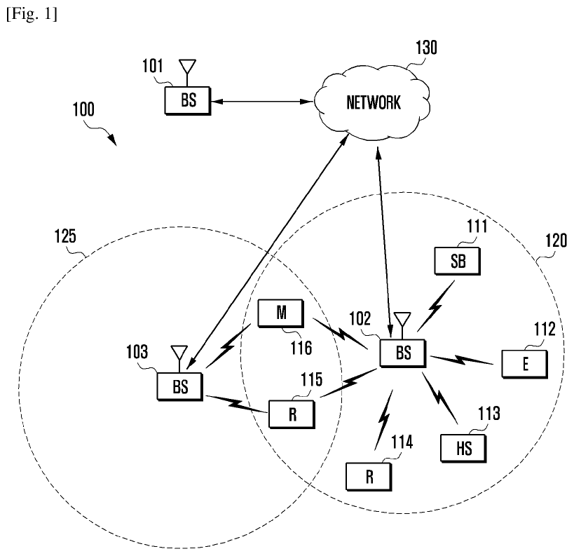

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network in-frastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

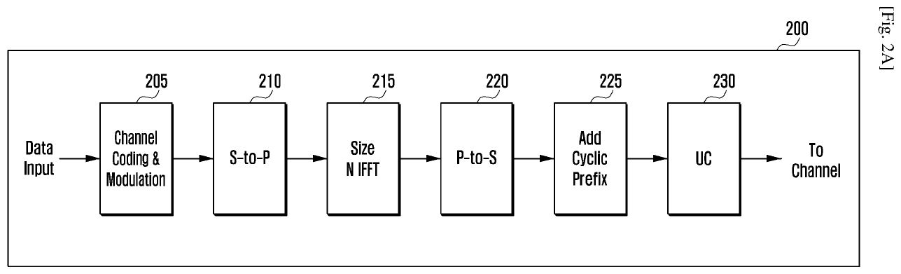

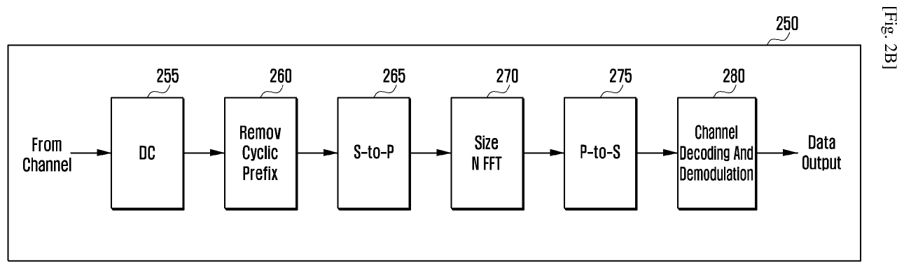

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

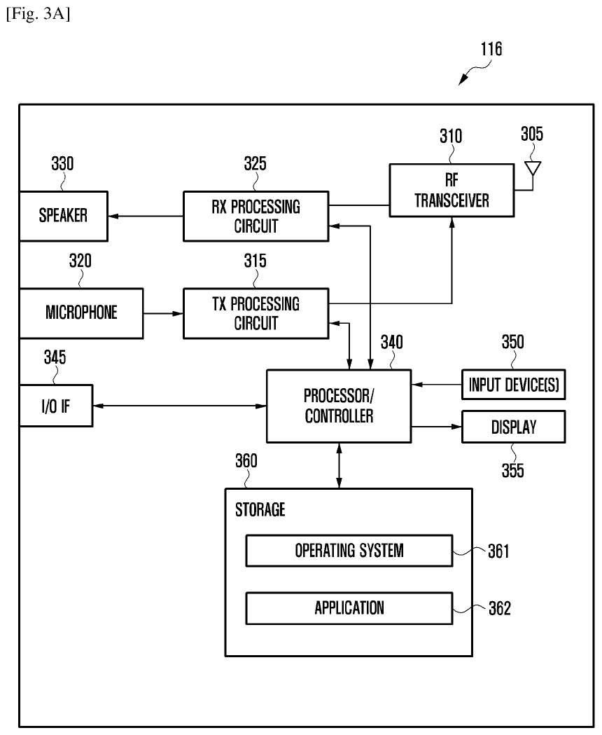

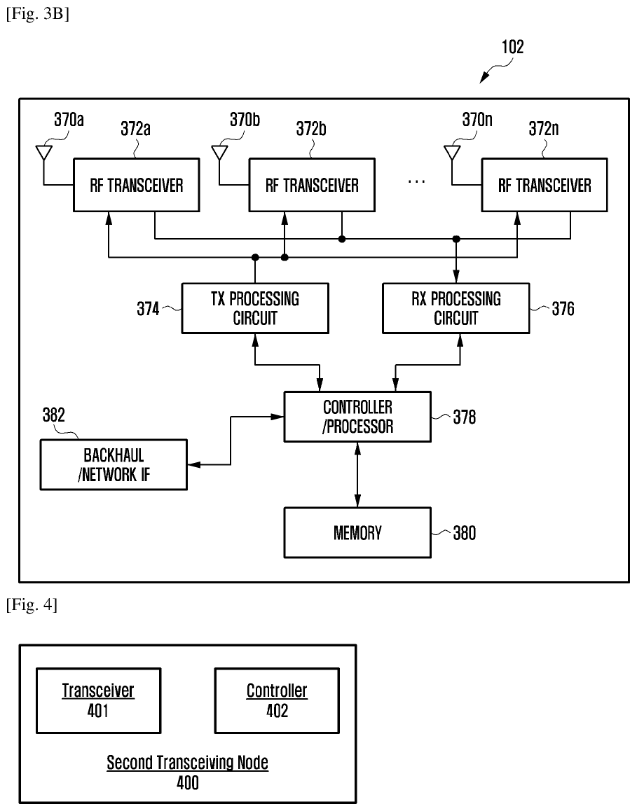

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a set-top box and other devices.

With the rapid development of information industry, especially the increasing demand from mobile Internet and internet of things (IoT), it brings unprecedented challenges to the future mobile communication technology. According to the report of International Telecommunication Union (ITU) ITU-R M.[IMT.BEYOND 2020.TRAFFIC], it can be predicted that by 2020, compared with 2010 (4G era), the growth of mobile traffic will be nearly 1000 times, and the number of UE connections will also exceed 17 billion, and the number of connected devices will be even more alarming, with the massive IoT devices gradually infiltrating into the mobile communication network. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable Hybrid Automatic Repeat request-Acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (e.g., a downlink slot or a downlink mini slot), the uplink time unit that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In 5G NR, due to the introduction of larger bandwidth and higher frequency band, the energy consumption of a base station is several times that of an LTE base station. How to reduce the energy consumption of the base station is a problem to be solved. Moreover, while reducing the energy consumption of the base station, how to reduce the impact on the network performance is also a problem to be solved.

In order to solve at least the above technical problems, embodiments of the disclosure provide a method performed by a terminal, the terminal, a method performed by a base station and the base station in a wireless communication system, and a non-transitory computer-readable storage medium. Hereinafter, various embodiments of the disclosure will be described in detail with reference to the accompanying drawings.

In embodiments of the disclosure, for the convenience of description, a first transceiving node and a second transceiving node are defined. For example, the first transceiving node may be a base station, and the second transceiving node may be a UE. In the following examples, the base station is taken as an example (but not limited thereto) to illustrate the first transceiving node, and the UE is taken as an example (but not limited thereto) to illustrate the second transceiving node.

Exemplary embodiments of the disclosure are further described below with reference to the drawings.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

FIG. 4 illustrates a block diagram of the second transceiving node according to an embodiment of the disclosure.

Referring to FIG. 4, the second transceiving node 400 may include a transceiver 401 and a controller 402.

The transceiver 401 may be configured to receive first data and/or first control signaling from the first transceiving node, and transmit second data and/or second control signaling to the first transceiving node in a determined time unit.

The controller 402 may be an application specific integrated circuit or at least one processor. The controller 402 may be configured to control the overall operation of the second transceiving node and control the second transceiving node to implement the methods proposed in embodiments of the disclosure. For example, the controller 402 may be configured to determine the second data and/or the second control signaling and a time unit for transmitting the second data and/or the second control signaling based on the first data and/or the first control signaling, and control the transceiver 401 to transmit the second data and/or the second control signaling to the first transceiving node in the determined time unit.

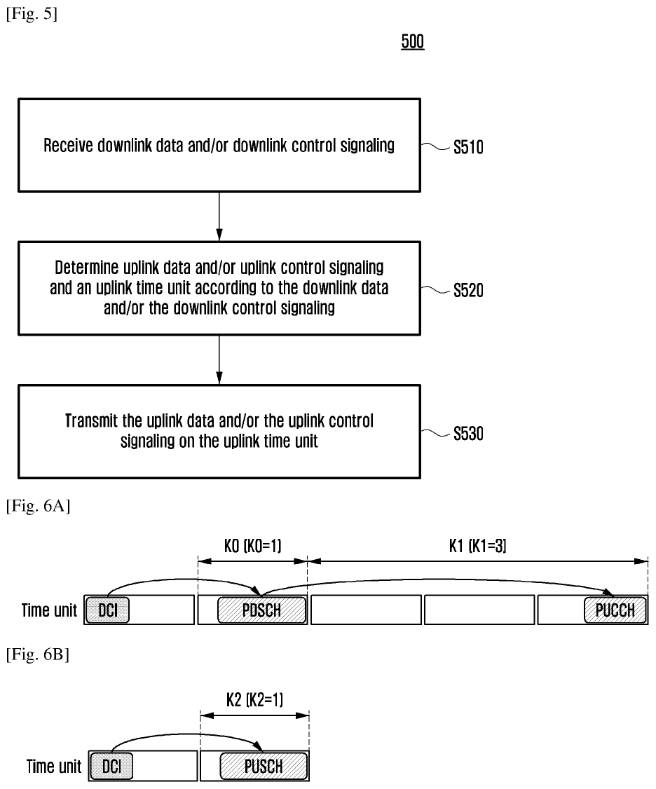

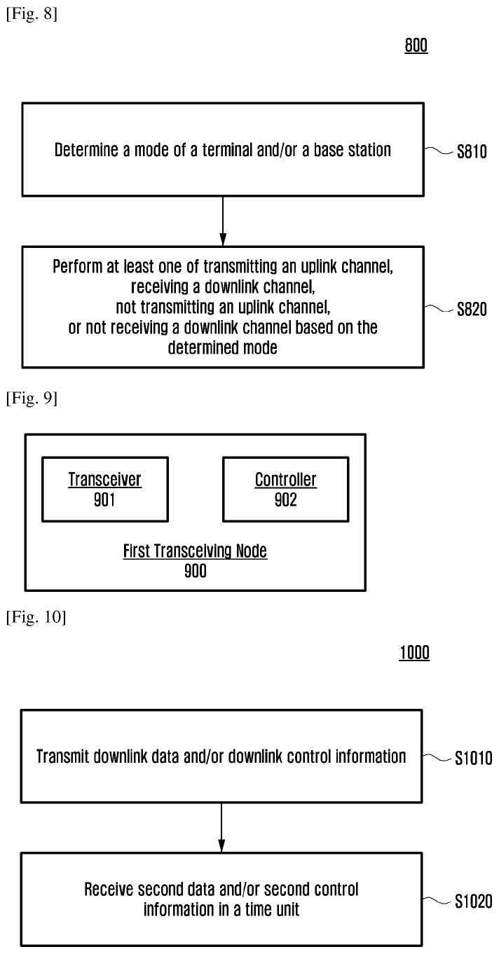

In some implementations, the controller 402 may be configured to perform one or more of operations in methods of various embodiments described below. For example, the controller 402 may be configured to perform one or more of operations in a method 500 to be described in connection with FIG. 5, and a method 800 to be described in connection with FIG. 8 later.

In some implementations, the first data may be data transmitted by the first transceiving node to the second transceiving node. In the following examples, downlink data carried by a PDSCH (Physical Downlink Shared Channel) is taken as an example (but not limited thereto) to illustrate the first data.

In some implementations, the second data may be data transmitted by the second transceiving node to the first transceiving node. In the following examples, uplink data carried by a PUSCH (Physical Uplink Shared Channel) is taken as an example to illustrate the second data, but not limited thereto.

In some implementations, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In some implementations, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information) or CG (Configured Grant) UCI. In embodiments of the disclosure, when UCI is carried by a PUCCH, the UCI may be used interchangeably with the PUCCH.

In some implementations, a PUCCH with a SR may be a PUCCH with a positive SR and/or negative SR. The SR may be the positive SR and/or the negative SR.

In some implementations, the CSI may also be Part 1 CSI and/or Part 2 CSI.

In some implementations, a first time unit is a time unit in which the first transceiving node transmits the first data and/or the first control signaling. In the following examples, a downlink time unit is taken as an example (but not limited thereto) to illustrate the first time unit.

In some implementations, a second time unit is a time unit in which the second transceiving node transmits the second data and/or the second control signaling. In the following examples, an uplink time unit is taken as an example (but not limited thereto) to illustrate the second time unit.

In some implementations, the time unit may be one or more slots, one or more sub-slots, one or more OFDM symbols, one or more spans, or one or more subframes.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (MAC CE).

FIG. 5 illustrates a flowchart of a method performed by a UE according to embodiments of the disclosure.

Referring to FIG. 5, in step S510, the UE may receive downlink data (e.g., downlink data carried by a PDSCH) and/or downlink control signaling from a base station. For example, the UE may receive the downlink data and/or the downlink control signaling from the base station based on predefined rules and/or received configuration parameters.

In step S520, the UE determines uplink data and/or uplink control signaling and an uplink time unit based on the downlink data and/or downlink control signaling.

In step S530, the UE transmits the uplink data and/or the uplink control signaling to the base station in an uplink time unit.

In some implementations, acknowledgement/negative acknowledgement (ACK/NACK) for downlink transmissions may be performed through HARQ-ACK.

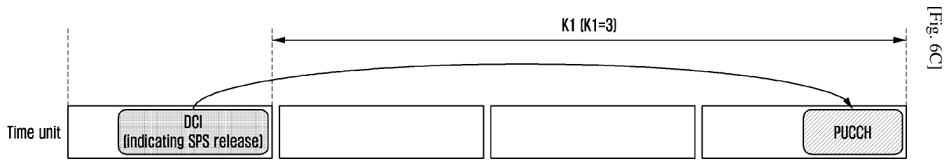

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 6A-6C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 6A gives an example in which K0=1. In the example illustrated in FIG. 6A, the time interval from the PDSCH scheduled by the DCI to the PDCCH carrying the DCI is one slot. In embodiments of the disclosure, “a UE receives DCI” may mean that “the UE detects the DCI”.

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 6B gives an example in which K2=1. In the example illustrated in FIG. 6B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in embodiments of the disclosure) and/or a PUSCH not scheduled by DCI (e.g., CG PUSCH).

In yet another example, the UE receives the PDSCH, and may transmit HARQ-ACK information for the PDSCH reception in a PUCCH in the uplink time unit. For example, a timing parameter (which may also be referred to as a timing value) K1 (e.g., the parameter dl-DataToUL-ACK in 3GPP) may be used to represent a time interval between the PUCCH for transmitting the HARQ-ACK information for the PDSCH reception and the PDSCH, and K1 may be in units of uplink time units, such as slots or sub-slots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 6A gives an example in which K1=3. In the example illustrated in FIG. 6A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K₁, the timing parameter K0 may be used interchangeably with a timing parameter K0, and the timing parameter K2 may be used interchangeably with a timing parameter K₂.

The PDSCH may be a PDSCH scheduled by the DCI and/or a SPS PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives the DCI (e.g., DCI indicating SPS (Semi-Persistent Scheduling) PDSCH release (deactivation)), and may transmit HARQ-ACK information for the DCI in the PUCCH in the uplink time unit. For example, the timing parameter K1 may be used to represent a time interval between the PUCCH for transmitting the HARQ-ACK information for the DCI and the DCI, and K1 may be in units of uplink time units, such as slots or sub-slots. For example, FIG. 6C gives an example in which K1=3. In the example of FIG. 6C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, the UE capability information is included in the PUSCH transmitted by the UE.

In some implementations, the base station may configure higher layer signaling for the UE based on a UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission. For example, the UE may be configured to multiplex UCIs with different priorities via higher layer signaling (e.g., through the 3GPP parameter UCI-MUXWithDifferentiatPriority). For example, if the UE is configured or provided with the 3GPP parameter UCI-MUXWithDifferentiatPriority, the UE multiplexes the UCIs with different priorities; otherwise, the UE performs prioritization for PUCCHs and/or PUSCHs with different priorities. For example, the two levels of priorities may include a first priority and a second priority which are different from each other. In an example, the first priority may be higher than the second priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority.

The multiplexing of multiple PUCCHs and/or PUSCHs that overlap in time domain may be multiplexing UCI information included in the PUCCHs in a PUCCH or PUSCH. For example, the multiplexing of a first uplink channel (e.g., PUCCH) and a second uplink channel (PUCCH or PUSCH) that overlap in time domain may include multiplexing UCI included in the first uplink channel in the second uplink channel.

The prioritization of two PUCCHs and/or PUSCHs that overlap in time domain by the UE may mean that the UE transmit a PUCCH or PUSCH with a higher priority, and does not transmit a PUCCH or PUSCH with a lower priority. For example, the prioritization of the first uplink channel (PUCCH or PUSCH) with the higher priority and the second uplink channel (PUCCH or PUSCH) with the lower priority that overlap in time domain may include the UE transmitting the first uplink channel with the higher priority, and not transmitting the second uplink channel with the lower priority.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by a UE, and the scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and the scrambling of the multicast PDSCH may be based on a UE-group common RNTI. For example, the UE-group common RNTI for scrambling the multicast PDSCH may include an RNTI (which is referred to as G-RNTI in embodiments of the disclosure) for scrambling of a dynamically scheduled multicast transmission (e.g., PDSCH) or an RNTI (which is referred to as G-CS-RNTI in embodiments of the disclosure) for scrambling of a multicast SPS transmission (e.g., SPS PDSCH). The G-CS-RNTI and the G-RNTI may be different RNTIs or same RNTI. UCI(s) of the unicast PDSCH may include HARQ-ACK information, SR, or CSI of the unicast PDSCH reception. UCI(s) of the multicast PDSCH may include HARQ-ACK information for the multicast PDSCH reception. In embodiments of the disclosure, “multicast” may also be replaced by “broadcast”.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be a PDCCH and/or DCI and/or DCI format. For example, a SPS PDSCH and/or CG PUSCH may be dynamically indicated in a corresponding activated DCI/DCI format/PDCCH. All or one or more of the described methods, steps and operations may be optional. For example, if a certain parameter (e.g., parameter X) is configured, the UE performs in a certain manner (e.g., manner A), otherwise (if the parameter, e.g., parameter X, is not configured), the UE performs in another manner (e.g., manner B).

It should be noted that, a PCell (Primary Cell) or PSCell (Primary Secondary Cell) in embodiments of the disclosure may be used interchangeably with a cell having a PUCCH.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling of multiple PDSCH/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured and/or indicated with a transmission with repetitions” may be understood that the number of the repetitions of the transmission is greater than 1. For example, “configured and/or indicated with a transmission with repetitions” may be replaced with “PUCCH repeatedly transmitted on more than one slot/sub-slot”. “Not configured and/or indicated with a transmission with repetitions” may be understood that the number of the repetitions of the transmission equals to 1. For example, “PUCCH that is not configured and/or indicated with repetitions” may be replaced by “PUCCH transmission with the number of the repetitions of 1”. For example, the UE may be configured with a parameter N_{PUCCH}^{repeat} related to the number of repetitions of PUCCH; When the parameter N_{PUCCH}^{repeat} is greater than 1, it may mean that the UE is configured with a PUCCH transmission with repetitions, and the UE may repeat the PUCCH transmission on N_{PUCCH}^{repeat} time units (e.g., slots); when the parameter is equal to 1, it may mean that the UE is not configured with a PUCCH transmission with repetitions. For example, the repeatedly transmitted PUCCH may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, the multiple manners described in the disclosure may be combined in any order. In a combination, a manner may be adopted one or more times.

It should be noted that, steps of methods of the disclosure may be implemented in any order.

It should be noted that, in methods of the disclosure, “canceling a transmission” may mean canceling the transmission of the entire uplink channel and/or cancelling the transmission of a part of the uplink channel.

It should be noted that, in methods of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in methods of the disclosure, a PUCCH/PUSCH carrying/with A may be understood as a PUCCH/PUSCH only carrying/with A, and may also be understood as a PUCCH/PUSCH carrying/with at least A.

It should be noted that “slot” may be replaced by “sub-slot” or “time unit” in embodiments of the disclosure.

It should be noted that, in embodiments of the disclosure, “a predefined method (or step) is performed if a predefined condition is satisfied” and “a predefined method (or step) is not performed if a predefined condition is not satisfied” may be used interchangeably. “A predefined method (or step) is not performed if a predefined condition is satisfied” and “a predefined method (or step) is performed if a predefined condition is not satisfied” may be used interchangeably.

In some cases, in order to reduce the energy consumption of the base station, the base station may operate in an energy-saving mode, for example, the base station does not transmit downlink signals and/or the base station does not receive uplink signals. If the UE does not know that the base station is in the energy-saving mode, the UE may receive and/or decode downlink channels which are not transmitted by the base station, and/or the UE may transmit uplink channels, but the base station may not receive the uplink channels transmitted by the UE, resulting in the increase of energy consumption of the UE and the degradation of uplink transmission performance.

In some implementations, at least one of the following manners may be adopted.

### Manner MN1

In manner MN1, an operating mode of the base station (e.g., whether it is an energy-saving mode) and/or an operating mode (or state) of the UE may be specified by protocols and/or configured by higher layer signaling and/or indicated by dynamic signaling. For example, there may be the following two modes, mode 1 and mode 2.

Mode 1 (it may also be referred to as “first mode” in embodiments of the disclosure): for example, mode 1 may be a non-energy-saving mode (also referred to as normal mode). In mode 1, normal communication (uplink transmission and/or downlink transmission) may be performed between the base station and the UE. For example, when in mode 1, the base station may transmit downlink channels and/or the base station may receive uplink channels. Or, when in mode 1, the UE may receive downlink channels transmitted by the base station and/or the UE may transmit uplink channels. It should be noted that, mode 1 may be an existing mode, for example, the mode in which the UE receives/transmits channels defined by 3GPP Rel-15, Rel-16 or Rel-17.

Mode 2 (it may also be referred to as a “second mode” in embodiments of the disclosure): for example, mode 2 may be an energy-saving mode. In mode 2, the base station may not perform some or all of downlink transmissions or uplink receptions. For example, when in mode 2, the base station may not transmit some or all of downlink channels and/or the base station may not receive some or all of uplink channels. Or, when in mode 2, the UE does not expect that the base station transmits some or all of downlink channels and/or the base station receive some or all of uplink channels.

In some implementations, a mode may be configured and/or indicated for the UE, where the mode is applicable to downlink reception and uplink transmission of the UE. Behaviors of the UE in this mode (e.g., downlink reception methods and uplink transmission methods) may also be specified by protocols. This method is simple to implement and can save signaling overhead.

In some implementations, a mode may be configured and/or indicated separately for downlink reception and uplink transmission of the UE, for example, a downlink mode corresponding to downlink reception and an uplink mode corresponding to uplink transmission; or, a mode may be configured and/or indicated for downlink reception or uplink transmission of the UE. Behaviors of the UE in the downlink mode (e.g., downlink reception methods) and/or behaviors of the UE in the uplink mode (e.g., uplink transmission methods) may also be specified by protocols. The UE may also report a UE capability of whether the UE supports a corresponding energy-saving mode separately for downlink reception and uplink transmission. This method can improve the flexibility of scheduling.

The method can reduce the energy consumption of the UE, and prevent the base station from not receiving the uplink channel transmitted by the UE, thereby improving the reliability of uplink transmission. The configuring of UE modes for downlink and uplink separately can further improve flexibility.

### Manner MN2

In manner MN2, mode 2 (e.g., energy-saving mode) in manner MN1 may be further divided into multiple different sub-modes. This method is illustrated by taking two sub-modes (e.g., two sub-energy-saving modes) divided from mode 2 as an example. However, the methods in embodiments of the disclosure are also applicable to more than two sub-modes (e.g., more than two sub-energy-saving modes). For example, the energy-saving mode may include the following two sub-energy-saving modes, mode 2-1 and mode 2-2. Mode 2-1 and mode 2-2 may correspond to different energy-saving levels. For example, compared with mode 2-2, mode 2-1 may correspond to a higher energy-saving level. That is, the energy consumption of the base station in mode 2-1 may be lower than that of the base station in mode 2-2.

Mode 2-1: for example, mode 2-1 is a high energy-saving mode corresponding to a higher energy-saving level. For example, when in mode 2-1, the base station does not transmit downlink channels (all or any downlink channels) and/or the base station does not receive uplink channels (all or any uplink channels). Or, when in mode 2-1, the UE does not expect that the base station transmits downlink channels and/or the base station receives uplink channels.

Mode 2-2: for example, mode 2-2 is a light energy-saving mode corresponding to a lower energy-saving level. For example, when in mode 2-2, the base station does not transmit predefined downlink channels and/or the base station does not receive predefined uplink channels. Or, when in mode 2-2, the UE does not expect that the base station transmits the predefined downlink channels and/or the base station receives the predefined uplink channels.

It should be noted that, the methods applicable to mode 2 in embodiments of the disclosure are also applicable to mode 2-1 and/or mode 2-2.

In some implementations, the UE may report a UE capability of the supported energy-saving modes. The base station may configure and/or indicate two or more modes (e.g., energy-saving mode and/or non-energy-saving mode) to the UE based on the capability reported by the UE.

This method can improve the flexibility of network energy saving. For example, it is possible to determine which energy-saving mode to be used based on a number of active users in the network (whether the number exceeds a threshold number). When there are fewer active users in the network, the high energy-saving mode may be used, and when there are more active users in the network, the light energy-saving mode may be used.

It should be noted that, the modes defined in embodiments of the disclosure may be modes for a serving cell, and/or modes for a bandwidth part (BWP), and/or modes for a channel. For example, in case of a mode for a serving cell (or BWP), transmission and/or reception methods for all channels on the serving cell (or BWP) in the mode may be specified. For example, in case of a mode for a channel, transmission and/or reception methods for the channel in the mode may be specified.

It will be understood that in embodiments of the disclosure, a certain mode of the base station and/or the terminal may be understood as an operation method (transmission and/or reception method) corresponding to the mode. For example, from the perspective of the UE, mode 1 may be understood as that the UE shall receive downlink channels and/or the UE would transmit uplink channels; mode 2 may be understood as that the UE will not receive all or some of the downlink channels and/or would not transmit all or some of the uplink channels. Therefore, in embodiments of the disclosure, for the UE, “mode 1” may be used interchangeably with that “the UE shall receive downlink channels and/or the UE would transmit uplink channels”; “mode 2” may be used interchangeably with that “the UE will not receive all or some of downlink channels and/or would not transmit all or some of uplink channels”; “mode 2-1” may be used interchangeably with that “the UE will not receive all downlink channels and/or would not transmit all uplink channels”; and “mode 2-2” may be used interchangeably with that “the UE will not receive predefined downlink channels and/or would not transmit predefined uplink channels”.

### Manner MN3

In manner MN3, a mode of the UE may be configured by higher layer signaling. The higher layer signaling may be cell specific signaling (e.g., SIB (System Information Block) signaling) and/or group common signaling and/or UE specific signaling. For example, the UE may be provided with a mode configuration, which may indicate one or more modes and a duration corresponding to each of the one or more modes. A time unit of the duration may be at least one of a slot, a symbol, a sub-frame, a frame, a half frame or a millisecond. A reference sub-carrier spacing (SCS) for the time unit may also be specified by protocols and/or configured by higher layer signaling (for example, the time unit of the duration is a slot or a symbol). The one or more modes may include the above first mode and/or second mode, and/or a flexible mode (which may also be referred to as a third mode in embodiments of the disclosure) to be described below.

In some implementations, modes (one mode or more than one mode) within a time period P may be configured for the UE. Additionally, the modes in the time period may be repeated periodically, for example, with a periodicity of P.

When multiple modes within the time period P are configured for the UE, corresponding parameters, such as a starting time and/or duration and/or periodicity, may be configured for each of the multiple modes. For example, the corresponding duration may be explicitly indicated for each mode, and the periodicity may be determined based on a sum of the duration of each mode. Or, the corresponding durations may be explicitly indicated for some of the multiple modes, and the durations of the remaining modes of the multiple modes may be determined based on a relationship between the durations of respective modes or a relationship between the durations of respective modes and the periodicity. The relationship between the durations of respective modes and the periodicity may be that a sum of the durations of the multiple modes is equal to the periodicity. As an example, for a mode configuration including N modes, where N is an integer greater than 1, durations of the first N−1 modes may only be indicated in the mode configuration, and a duration of the last mode may be determined based on a sum of the durations of the first N−1 modes and the periodicity.

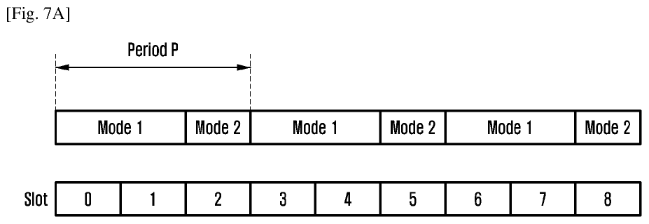

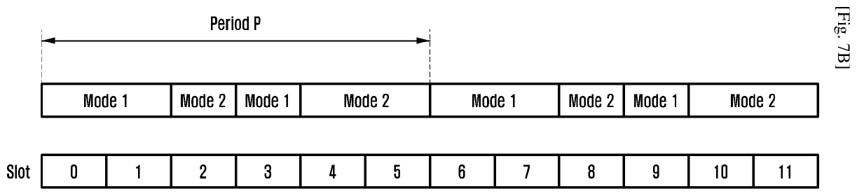

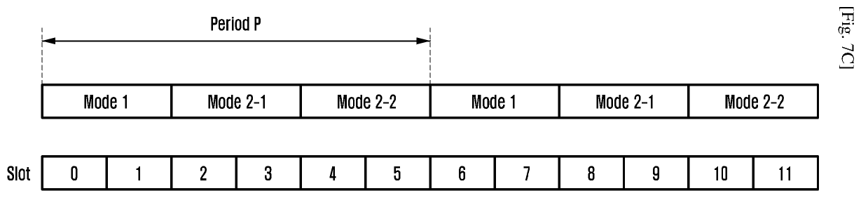

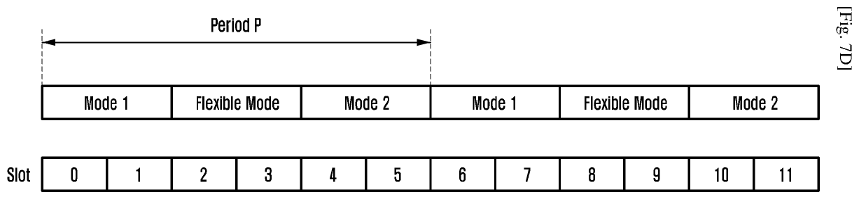

For example, at least one mode and a duration of each of the at least one mode may be configured in a time sequence (e.g., increasing order of indexes or decreasing order of indexes of time units (e.g., slots)) in one period. Multiple {mode, duration} may constitute a list. A time unit of the duration may be at least one of a slot, a symbol, a sub-frame, a frame, a half frame. A reference SCS for the time unit may also be specified by protocols and/or configured by higher layer signaling. A specific example in which the mode of the UE is configured is illustrated below in connection with FIGS. 7A-7D.

FIGS. 7A-7D illustrate examples of mode configurations according to some embodiments of the disclosure. It will be understood that a length of a periodicity P, lengths of durations of respective modes, and a number of modes and an arrangement thereof in the periodicity in FIGS. 7A-7D are only examples, and the embodiments of the disclosure are not limited thereto, and any suitable periodicity and duration may be adopted, and the number of the modes and the arrangement thereof in the periodicity may also be modified.

In a specific example, as shown in FIG. 7A, the periodicity P may be configured to be 3 slots, where a duration of mode 1 is 2 slots and a duration of mode 2 is 1 slot. Mode 1 is repeated with the periodicity of 3 slots, that is, slots 0, 1, 3, 4, 6 and 7 correspond to mode 1. Mode 2 is repeated with the periodicity of 3 slots, that is, slots 2, 5 and 8 correspond to mode 2.

In another specific example, as shown in FIG. 7B, the periodicity P may be configured to be 6 slots, where there are mode 1 with a duration of 2 slots, mode 2 with a duration of 1 slot, mode 1 with a duration of 1 slot and mode 2 with a duration of 2 slots in time sequence in the periodicity P. For example, the modes in the periodicity P may be configured by a configuration list including 4 elements. The 4 elements are: {mode 1, 2 slots}, {mode 2, 1 slot}, {mode 1, 1 slot}, and {mode 2, 2 slots}.

It should be noted that the same configuration effect can also be achieved by other manners. For example, it may be configured by a bitmap, where “0” and “1” correspond to two different modes. For another example, multiple configuration parameters may be adopted instead of the configuration list. For example, the following parameters may be configured for the UE: a first mode, a duration of the first mode, a second mode, and a duration of the second mode. Only one of the duration of the second mode and the periodicity P may be configured, and the other parameter may be determined by “periodicity P=the duration of first mode+the duration of the second mode”.

In embodiments of the disclosure, the method for configuration based on two types of modes (mode 1 and mode 2) may also be used for configuration based on multiple types of modes (mode 1, mode 2-1 and mode 2-2). For example, as shown in FIG. 7C, the periodicity P may be configured to be 6 slots, where there are mode 1 with a duration of 2 slots, mode 2-1 with a duration of 2 slots and mode 2-2 with a duration of 2 slots in time sequence in the periodicity P. For example, the modes in the periodicity P may be configured by a configuration list including 3 elements which are {mode 1, 2 slots}, {mode 2-1, 2 slots} and {mode 2-2, 2 slots} separately.

In some implementations, a flexible mode may also be configured for the UE. For example, the flexible mode may be a pending mode, which may be rewritten into other modes (e.g., mode 1 or mode 2) by other signaling. For example, as shown in FIG. 7D, the periodicity P may be configured to be 6 slots, where there are mode 1 with a duration of 2 slots, flexible mode with a duration of 2 slots and mode 2 with a duration of 2 slots separately in time sequence in the periodicity P. For example, the modes in the periodicity P may be configured by a configuration list including 3 elements which are {mode 1, 2 slots}, {flexible mode, 2 slots} and {mode 2, 2 slots} respectively. For another example, the flexible mode may be an intermediate mode in which the first mode is changed to the second mode and/or an intermediate mode in which the second mode is changed to the first mode.

In some implementations, a starting time of the first periodicity of the mode configuration may also be configured, which may be configured by an absolute time (e.g., a specific time) or a relative time (e.g., a time interval relative to received signaling).

It should be noted that, the method of receiving and/or transmitting signals by the UE in different modes may also be specified by protocols and/or configured by higher layer signaling. The method configuring the mode of the UE can enable the UE to reduce the reception and/or transmission of some or all signals in a specific mode, thereby reducing the power consumption of the UE.

In some implementations, the mode may be implicitly indicated by a slot format configured by higher layer signaling (e.g., 3GPP parameter tdd-UL-DL-ConfigurationCommon and/or tdd-UL-DL-ConfigurationDedicated). For example, for downlink, if the slot format is configured as downlink, the corresponding mode is mode 1; and/or if the slot format is configured as uplink, the corresponding mode is mode 2. For another example, for uplink, if the slot format is configured as downlink, the corresponding mode is mode 2, and if the slot format is configured as uplink, the corresponding mode is mode 1. The method is simple to implement and can reduce the implementation complexity of the UE and the base station.

### Manner MN4

In some implementations, the method of changing or switching between different modes may also be specified by protocols and/or configured by higher layer signaling. For example, it may be specified that a mode configured by cell specific signaling may be changed (e.g., rewritten/overwritten) by a mode configured by UE specific signaling. As an example, a flexible mode configured by cell specific signaling may be changed (e.g., rewritten/overwritten) to a specific mode (e.g., mode 1 or mode 2) by UE specific signaling. As another example, a flexible mode configured by cell specific signaling and/or UE specific signaling may be changed (e.g., rewritten/overwritten) to a specific mode (e.g., mode 1 or mode 2) by dynamic signaling. The dynamic signaling may be a specific DCI format for indicating the mode. For example, CRC of the specific DCI format may be scrambled by a specific RNTI for energy saving. The RNTI for energy saving may be an RNTI for network energy saving or an RNTI for UE energy saving (e.g., Power Saving (PS)-RNTI). The dynamic signaling may also be a DCI format for scheduling data and/or triggering uplink transmission. The dynamic signaling may also be DCI format 20, and the mode may be indicated by a slot format indication. For example, for downlink, if the slot format indication is downlink, a corresponding mode is mode 1, and if the slot format indication is uplink, the corresponding mode is mode 2. For another example, for uplink, if the slot format indication is downlink, the corresponding mode is mode 2, and if the slot format indication is uplink, the corresponding mode is mode 1. At this time, CRC of DCI format 20 may be scrambled with an SFI-RNTI or a specific RNTI for energy saving. The specific RNTI for energy saving may also be configured separately for downlink and uplink on a serving cell (e.g., for a serving cell of TDD).

It should be noted that, in embodiments of the disclosure, the switching/change method of switching/changing the flexible mode to a specific mode may also be applicable to switching/change among multiple specific modes, such as the change from the first mode (e.g., mode 1) to the second mode (e.g., mode 2) and/or the change from the second mode to the first mode.

In some implementations, the UE may be indicated to change from one of the first mode (e.g., mode 1) and the second mode (e.g., mode 2) to the other of the first mode and the second mode by predefined downlink signaling. In some examples, a change from the second mode (e.g., mode 2) to the first mode (e.g., mode 1) may be indicated by the predefined downlink signaling. For example, when the UE receives a DCI format scheduling a PDSCH and/or a PUSCH, the UE will change from the second mode (e.g., mode 2) to the first mode (e.g., mode 1). For another example, when the UE receives the predefined downlink signaling (e.g., a specific sequence, or a specific group common DCI format, or a DCI format indicating SPS (or CG PUSCH) activation, or a DCI format indicating TCI state update), the UE will change from the second mode (e.g., mode 2) to the first mode (e.g., mode 1). Optionally, it may be further specified that the UE will change from the second mode (e.g., mode 2) to the first mode (e.g., mode 1) at a time that is T1 time after receiving signaling indicating the mode change.

In some implementations, the UE may change from the second mode (e.g., mode 2) to the first mode (e.g., mode 1) after transmitting predefined uplink signaling (e.g., a specific sequence, or a specific PUCCH, or a PRACH, a SR or a CG PUSCH). For example, the UE may change from the second mode (e.g., mode 2) to the first mode (e.g., mode 1) after T2 time after transmitting the predefined uplink signaling. For example, it may be specified by protocols that T2 may be a time interval between the end symbol (or time) of a physical channel carrying the predefined uplink signaling and the starting symbol (or time) of another uplink channel (e.g., a PUCCH with a SR, a CG PUSCH or a PRACH). In an example, after T2 time after the UE transmit the predefined uplink signaling, the UE may transmit the SR and/or CG PUSCH, and if an interval between a SR (or CG PUSCH) and the end symbol (or time) of the physical channel with the predefined uplink signaling is less than T2, the UE may not transmit the SR (or CG PUSCH).

It should be noted that the mode change in embodiments of the disclosure may be a mode change for downlink and/or uplink. For example, the “change from the second mode (e.g., mode 2) to the first mode (e.g., mode 1)” may be a change from the second mode (e.g., mode 2) to the first mode (e.g., mode 1) for downlink and/or uplink. For example, the UE may change from the second mode (e.g., mode 2) to the first mode (e.g., mode 1) on a downlink serving cell (e.g., Pcell) after T4 time after transmitting the predefined uplink signaling. For another example, the UE may monitor a predefined PDCCH and/or search space after T4 time after transmitting the predefined uplink signaling. In the predefined search space, the UE detects a specific DCI format, which may explicitly and/or implicitly indicate the operating mode. In this way, the reliability of the mode change can be ensured, and the inconsistent understanding of the operating mode between the UE and the base station after miss detection of the predefined uplink signaling by the base station can be avoided, thereby improving the reliability of uplink transmission. In some implementations, a duration T3 for the changed mode after the UE changes the mode may be further specified.

In some implementations, T1, T2, T3, or T4 may be based on a UE capability report, or specified by protocols, or configured by higher layer signaling. T1, T2, T3 or T4 may be in units of slots or symbols.

In some implementations, T2 and/or T4 may be configured by higher layer signaling. Because of the different processing capabilities of base stations, different base stations may have different times to change to the first mode after receiving the predefined uplink signaling transmitted by the UE. Therefore, the flexibility can be improved by configuring T2 and/or T4 by higher layer signaling. It may also be specified by protocols that T2 (or T4) configured by higher layer parameters cannot be less than a T2 (or T4) value reported by the UE through a capability. This can ensure that the UE has the capability to switch within a specified time.

It should be noted that the method of mode change in embodiments of the disclosure may be applicable to downlink reception and uplink transmission of the UE at the same time. Or, the method of mode change in embodiments of the disclosure may be applicable to downlink reception or uplink transmission of the UE, respectively.

This method defines the manner in which the mode is rewritten, which can improve the flexibility of configuring of the energy-saving mode by the network. By changing (for example, rewriting) the operating mode when data arrives, for example, changing from the energy-saving mode to the non-energy-saving mode, the delay of data scheduling can be reduced.

### Manner MN5

In some implementations, the predefined downlink signaling may include at least one of:
first predefined downlink signaling: the first predefined downlink signaling may indicate a state (for example, a specific sequence; for another example, an energy signal), for example, which may correspond to a change manner (e.g., the change from the first mode (e.g., mode 1) to the second mode (e.g., mode 2)) or a mode (e.g., the second mode). For example, after the UE receives the first predefined downlink signaling, the UE may change from the first mode (e.g., mode 1) to the second mode (e.g., mode 2). For another example, after the UE receives the first predefined downlink signaling, the UE cannot change from the second mode (e.g., mode 2) to the first mode (e.g., mode 1). For yet another example, after the UE receives the first predefined downlink signaling, the UE maintains in the second mode or the UE may change from the first mode (e.g., mode 1) to the second mode (e.g., mode 2). The method can dynamically indicate the UE to change from the non-energy-saving mode to the energy saving mode, and can reduce the power consumption of the UE.
second predefined downlink signaling: the second predefined downlink signaling may indicate a state (for example, a specific sequence; for another example, an energy signal), for example, which may correspond to a change manner (e.g., the change from the second mode (e.g., mode 2) to the first mode (e.g., mode 1)) or a mode (e.g., the first mode). For example, after the UE receives the second predefined downlink signaling, the UE may change from the second mode (e.g., mode 2) to the first mode (e.g., mode 1). For another example, after the UE receives the second predefined downlink signaling, the UE cannot change from the first mode (e.g., mode 1) to the second mode (e.g., mode 2). For yet another example, after the UE receives the second predefined downlink signaling, the UE maintains in the first mode or the UE may change from the second mode (e.g., mode 2) to the first mode (e.g., mode 1). The method can dynamically indicate the UE to change from the energy-saving mode to the non-energy-saving mode, and can reduce the delay.
third predefined downlink signaling: the third predefined downlink signaling may indicate more than one state (or mode), for example, each of which may correspond to a change manner (the change from the first mode (e.g., mode 1) to the second mode (e.g., mode 2), or the change from the second mode to the first mode (e.g., mode 1)), or be maintained in a same mode. For example, the third predefined downlink signaling may indicate two states (e.g., a first state and a second state) (for example, two sequences corresponding to the two states respectively; for another example, 1 bit of which a value indicates one of the two states, where the value 1 indicate the first state (or the first mode) and the value ‘0’ indicate the second state (or the second mode)), and the two states correspond to two change manners (the change from the first mode (e.g., mode 1) to the second mode (e.g., mode 2) and the change from the second mode to the first mode (e.g., mode 1), respectively. After the UE receives the third predefined downlink signaling indicating the first state (or the first mode), the UE may change from the second mode (e.g., mode 2) to the first mode (e.g., mode 1), or the UE may maintain in the first mode. After the UE receives the third predefined downlink signaling indicating the second state (or the second mode), the UE may change from the first mode (e.g., mode 1) to the second mode (e.g., mode 2), or the UE may maintain in the second mode. Compared with the previous two methods, this method can further improve the flexibility of scheduling.

As described above, the first predefined downlink signaling or the second predefined downlink signaling may indicate a mode change manner, and the third predefined downlink signaling may indicate one of multiple different mode change manners. It should be noted that the mode change manners and corresponding indication or configuration methods in the above embodiments are only examples, and there may also be other mode change manners and corresponding indication or configuration methods. For example, a mode to be changed to (e.g., an index corresponding to the mode) may be indicated in the predefined downlink signaling.

### Manner MN6

In some implementations, the predefined downlink signaling may be carried by a predefined downlink DCI format. The predefined downlink DCI format may be a new DCI format. The predefined downlink DCI format may be a group common DCI. The predefined downlink DCI format may indicate multiple predefined downlink signalings, one of which may be at least one of:
predefined downlink signaling corresponding to a serving cell.
predefined downlink signaling corresponding to a BWP (bandwidth part) of a serving cell.
predefined downlink signaling corresponding to a frequency domain unit of a serving cell. For example, the frequency domain unit may be a set of RBs or RB groups configured by higher layer signaling.
predefined downlink signaling corresponding to a predefined frequency domain and/or spatial domain resource. The spatial domain resource may indicate a TRP, an antenna port, and/or the like.
predefined downlink signaling corresponding to a channel on a serving cell and/or a BWP.

The ordering rule of the multiple predefined downlink signalings may be configured by higher layer signaling. For example, the multiple predefined downlink signalings that may be indicated by a DCI format are {predefined downlink signaling 1, predefined downlink signaling 2, predefined downlink signaling 3}, where the respective predefined downlink signaling correspond to different serving cells, and cell IDs corresponding to the respective predefined downlink signaling may be configured by higher layer signaling.

In some implementations, CRC of the predefined downlink DCI format may be scrambled by a specific RNTI for energy saving. The RNTI for energy saving may be an RNTI for network energy saving or an RNTI for UE energy saving (e.g., PS-RNTI).

The method can improve the accuracy of indicating mode switching and the flexibility of scheduling.

### Manner MN13

In some implementations, when the UE does not receive a mode indication (for mode change or switching) DCI in a monitoring occasion in which the mode indication (for mode change or switching) DCI is configured to be received, the UE may be specified by protocols and/or configured by higher layer signaling to perform at least one of:
entering the first mode;
entering the second mode;
the UE keeping the current mode unchanged.

For example, the entered mode may be up to UE implementation.

For example, the mode of the UE may be determined by a configuration of higher layer signaling.

The method defines the behavior of the UE when miss detection of the DCI occurs, which can improve the reliability of transmission.

### Manner MN7

In some implementations, the predefined uplink signaling may include at least one of:
first predefined uplink signaling: the first predefined uplink signaling may indicate a state (for example, a specific sequence; for another example, an energy signal), for example, which may correspond to a conversion manner (e.g., the change from the first mode (e.g., mode 1) to the second mode (e.g., mode 2)) or a mode (e.g., the second mode). For example, after the UE transmits the first predefined uplink signaling, the UE may change from the first mode (e.g., mode 1) to the second mode (e.g., mode 2). For another example, after the UE transmits the first predefined uplink signaling, the UE cannot change from the second mode (e.g., mode 2) to the first mode (e.g., mode 1). For yet another example, after the UE transmits the first predefined uplink signaling, the UE maintains in the second mode or the UE may change from the first mode (e.g., mode 1) to the second mode (e.g., mode 2). The method can dynamically indicate the UE to change from the non-energy-saving mode to the energy saving mode, and can reduce the power consumption of the UE.
second predefined uplink signaling: the second predefined uplink signaling may indicate a state (for example, a specific sequence; for another example, an energy signal), for example, which may correspond to a change manner (e.g., the change from the second mode (e.g., mode 2) to the first mode (e.g., mode 1)) or a mode (e.g., the first mode). For example, after the UE transmits the second predefined uplink signaling, the UE may change from the second mode (e.g., mode 2) to the first mode (e.g., mode 1). For another example, after the UE transmits the second predefined uplink signaling, the UE cannot change from the first mode (e.g., mode 1) to the second mode (e.g., mode 2). For yet another example, after the UE transmits the second predefined uplink signaling, the UE maintains in the first mode or the UE may change from the second mode (e.g., mode 2) to the first mode (e.g., mode 1). The method can dynamically indicate the UE to change from the energy-saving mode to the non-energy-saving mode, and can reduce the delay.
third predefined uplink signaling: the third predefined uplink signaling may indicate more than one state (or mode), for example, each of which may correspond to a change manner (the change from the first mode (e.g., mode 1) to the second mode (e.g., mode 2), or the change from the second mode to the first mode (e.g., mode 1)), or be maintained in a same mode. For example, the third predefined uplink signaling may indicate two states (for example, two sequences corresponding to the two states respectively; for another example, 1 bit of which a value indicates one of the two states, where the value ‘1’ indicates a first state (or the first mode) and the value ‘0’ indicates a second state (or the second mode)), and the two states correspond to two change manners (the change from the first mode (e.g., mode 1) to the second mode (e.g., mode 2) and the change from the second mode to the first mode (e.g., mode 1), respectively. After the UE transmits the third predefined uplink signaling indicating the first state (or the first mode), the UE may change from the second mode (e.g., mode 2) to the first mode (e.g., mode 1), or the UE may maintain in the first mode. After the UE transmits the third predefined uplink signaling indicating the second state (or the second mode), the UE may change from the first mode (e.g., mode 1) to the second mode (e.g., mode 2), or the UE may maintain in the second mode. Compared with the previous two methods, this method can further improve the flexibility of scheduling.

It should be noted that, in embodiments of the disclosure, the method for mode change may also be applicable to the reception and/or transmission method for a specific channel of the UE. For example, the first mode may be or correspond to the UE receiving a first channel or transmitting a second channel, and the second mode may be or correspond to the UE not receiving the first channel or not transmitting the second channel.

### Manner MN14

In some implementations, the predefined signaling may be predefined downlink signaling and/or predefined uplink signaling. The predefined downlink signaling may be carried by a predefined DCI format. The predefined DCI format may be a new DCI format. The predefined DCI format may be a group common DCI. The predefined DCI format may indicate multiple predefined signalings, one of which may be at least one of:
predefined signaling corresponding to a serving cell.
predefined signaling corresponding to a BWP of a serving cell.
predefined signaling corresponding to a frequency domain unit of a serving cell.

For example, the frequency domain unit may be a set of RBs or RB groups configured by higher layer signaling.
predefined signaling corresponding to a predefined frequency domain and/or spatial domain resource. The spatial domain resource may indicate a TRP, an antenna port, and/or the like.
predefined signaling corresponding to a channel on a serving cell and/or a BWP.
predefined signaling corresponding to a time unit of a serving cell. The time unit may be configured by higher layer signaling or specified by protocols. For example, the time unit may be a slot.

The ordering rule of the multiple predefined signalings may be configured by higher layer signaling and/or specified by protocols. For example, the multiple predefined signalings that may be indicated by a DCI format are {predefined signaling 1, predefined signaling 2, predefined signaling 3}, and the three predefined signalings correspond to 3 bits in a field in the DCI format, respectively. For example, the first bit corresponds to predefined signaling 1, the second bit corresponds to predefined signaling 2, and the third bit corresponds to predefined signaling 3. The predefined signaling may correspond to a time unit of a serving cell, each predefined signaling corresponds to a time unit of a different serving cell, or each predefined signaling correspond to one of multiple time units of a serving cell respectively. The ordering of the multiple predefined signalings in the DCI format may be specified by protocols.

The ordering rule may be one of the following:
in an ascending order (or descending order) of cell indexes.
ordering in time sequence for a same serving cell.
a predefined downlink signaling may be before or after a predefined uplink signaling for a same serving cell.
the predefined signaling may be before or after the predefined uplink signaling for a same time unit of a same serving cell.

In one example, the multiple predefined signalings may be first ordered in an ascending order of cell indexes, and then may be ordered in time sequence for a same serving cell. A predefined signaling of the predefined signalings may indicate an uplink slot and a downlink slot of a serving cell at the same time. Or, a predefined signaling of the predefined signalings may indicate whether cell DTX (discontinuous transmission)/DRX (discontinuous reception) in a slot of the cell is in active time.

In another example, the multiple predefined signalings may be first ordered in an ascending order of cell indexes, and then may be ordered in time sequence for a same serving cell. For a same time unit of a same serving cell, a predefined downlink signaling is before a predefined uplink signaling. A predefined signaling of the predefined signalings may indicate an uplink slot or a downlink slot of a serving cell. Or, a predefined signaling of the predefined signalings may indicate whether cell DTX or cell DRX in a slot of the cell is in active time. For example, the predefined downlink signaling may indicate the cell DTX, and the predefined uplink signaling may indicate the cell DRX.

This method can improve the flexibility of dynamic indicating.

### Manner MN8

In some implementations, the predefined uplink signaling may be at least one of:
predefined uplink signaling corresponding to a serving cell.
predefined uplink signaling corresponding to a BWP (bandwidth part) of a serving cell.
predefined uplink signaling corresponding to a frequency domain unit of a serving cell. For example, a frequency domain unit may be a set of RBs or RB groups configured by higher layer signaling.
predefined uplink signaling corresponding to a predefined frequency domain and/or spatial domain resource. The spatial domain resource may be a TRP, an antenna port, a beam, and/or the like.
predefined uplink signaling corresponding to a channel on a serving cell and/or a BWP.
predefined uplink signaling corresponding to one or more CG PUSCH configurations, for example, predefined uplink signaling corresponding to a CG PUSCH configuration with the higher (or lower) priority. For another example, the corresponding predefined uplink signaling may be configured in the CG PUSCH configuration.
predefined uplink signaling corresponding to one or more SR configurations, for example, predefined uplink signaling corresponding to a SR configuration with the higher (or lower) priority. For another example, the corresponding predefined uplink signaling may be configured in the SR configuration.

It should be noted that, when multiple predefined uplink signalings conflict in time domain, the UE may transmit one predefined uplink signaling thereof. The one predefined uplink signaling may be predefined uplink signaling with the higher priority. For another example, the one predefined uplink signaling may be determined up to UE implementation.

It should be noted that, “a serving cell” in embodiments of the disclosure may also be replaced by “multiple serving cells” The blind detection of the base station can be reduced by using a same signaling indication for multiple serving cells, thereby further reducing the energy consumption of the base station. It may also be implemented by a manner of configuration by the base station, for example, a manner that the same predefined uplink signaling is configured for multiple serving cells.

The method can improve the accuracy and flexibility of indicating uplink mode switching, and can indicate the base station to blindly detect specific signals, thereby saving the energy consumption of the base station.

### Manner MN9

In some implementations, the predefined uplink signaling may include at least one of:
a SR: for example, a SR with a smallest (or largest) index; for another example, a SR with the higher (or lower) priority that has a smallest (or largest) index; for another example, a SR that is configured to be the predefined uplink signaling by specific higher layer signaling in a SR configuration parameter (e.g., 3GPP parameter SchedulingRequestResourceConfig) and/or a logical channel configuration parameter (e.g., 3GPP parameter LogicalChannelConfig) corresponding to the SR. The method may be applicable for the UE to report one state. The method is simple to implement, which can reduce the implementation complexity of the UE and the base station. In addition, the method can avoid increasing the transmission delay of specific uplink data while reducing the energy consumption of the base station, and improve the reliability of uplink transmission.
a CG PUSCH: for example, a CG PUSCH with a smallest (or largest) index; for another example, a CG PUSCH with the higher (or lower) priority that has the smallest (or largest) index; for another example, a CG PUSCH that is configured to be the predefined uplink signaling by specific higher layer signaling in a CG PUSCH configuration parameter (e.g., 3GPP parameter ConfiguredGrantConfig). The method can avoid increasing the transmission delay of specific uplink data while reducing the energy consumption of the base station, and improve the reliability of uplink transmission.
a specific PUCCH resource. The method may be applicable for the UE to report one state and/or multiple states, and can improve the flexibility of scheduling.

It should be noted that, the methods defined in embodiments of the disclosure may be applicable to a serving cell; it may also be applicable to a specific frequency domain resource of a serving cell, e.g., a BWP; it may further be applicable to one or more specific channels.

### Manner MN10

In some implementations, the mode of the terminal and/or the base station may be determined based on whether one or more timers are running. For example, when the timer is running, it is determined to be a certain mode (e.g., the first mode), and when the timer is not running, it is determined to be another mode (e.g., the second mode) different from the mode. It may be specified by protocols and/or configured by higher layer signaling that the reception and/or transmission of at least one of the following channels may start or restart the timer:
a downlink channel satisfying Predefined Condition 1;
an uplink channel satisfying Predefined Condition 2.

It should be noted that the above channels may correspond to the same timer or different timers.

It should be noted that, the reception of the downlink channel satisfying Predefined Condition 3 and/or the transmission of the uplink channel satisfying Predefined Condition 4 may also be based on discontinuous reception (DRX). For example, in an active state, the UE may receive and/or transmit channels, and in an inactive state, the UE does not receive and/or transmit the channels.

In some implementations, a corresponding timer may be configured for each of one or more modes. Or, a common timer may be configured for two or more of the one or more modes.

In some examples, a duration of a timer corresponding to each mode may be the same or different from each other. For example, a duration of a timer corresponding to the first mode may be longer than that of a timer corresponding to the second mode.

In some implementations, when a timer corresponding to a mode (e.g., the first mode) expires, it may automatically change to another mode (e.g., the second mode).

In some implementations, Predefined Condition 1 may include at least one of:
a PDSCH scheduled by DCI.
a downlink physical channel configured by higher layer signaling to be received, e.g., SPS PDSCH. For example, when the UE is configured and/or indicated to be in a specific mode, the UE may receive SPS PDSCHs, or the UE may receive a specific SPS PDSCH. The specific SPS PDSCH may be a SPS PDSCH with the higher priority. The specific SPS PDSCH may be a SPS PDSCH configured and/or indicated by higher layer signaling that it should be received in the specific mode (e.g., mode 2). For example, it may be configured by a parameter in a SPS PDSCH configuration parameter (for example, in a 3GPP parameter SPS-Config) that the SPS PDSCH is received when in the specific mode. This can improve the flexibility of SPS PDSCH scheduling.
a specific PDCCH. For example, the specific PDCCH may be a PDCCH configured to be received in a common search space (CSS). For example, the specific PDCCH may be a PDCCH configured to be received in a UE specific search space (USS). For another example, the specific PDCCH may be a PDCCH configured and/or indicated by higher layer signaling to be received in a specific mode (e.g., mode 2). For example, it may be configured by a parameter in a search space parameter (e.g., 3GPP parameters SearchSpace, and SearchSpaceExt-r16) that a PDCCH in the search space is received when in the specific mode. In this way, the power consumption of the UE can be reduced, on the premise of ensuring the downlink scheduling performance.
a predefined synchronization signal (SS)/physical broadcast channel (PBCH) block. The base station may configure the predefined SS/PBCH block that should be received in a specific mode (e.g., mode 2) through higher layer signaling, thus saving the energy consumption of the UE.
a channel state information reference signal (CSI-RS). The CSI-RS may be all CSI-RSs or predefined CSI-RSs, for example, the predefined CSI-RSs that the UE should receive in a specific mode (e.g., mode 2) may be configured by higher layer signaling (e.g., configured by a parameter in a CSI-RS configuration parameter). This can improve the flexibility of CSI-RS reception.
a phase tracking reference signal (PT-RS).

As described above, Predefined Condition 1 may include one or more of the listed items (the PDSCH scheduled by DCI, the downlink physical channel configured by higher layer signaling to be received, the specific PDCCH, the predefined SS/PBCH block, the CSI-RS, and the PT-RS). The following is an example of how to determine whether Predefined Condition 1 is satisfied when Predefined Condition 1 includes one or more of the listed items. When Predefined Condition 1 includes one (for example, the specific PDCCH) of the listed items, if a downlink channel is the specific PDCCH, the downlink channel satisfies Predefined Condition 1 (is associated with Predefined Condition 1), otherwise, the downlink channel does not satisfy Predefined Condition 1 (is not associated with Predefined Condition 1). When Predefined Condition 1 includes multiple (for example, the downlink physical channel configured by higher layer signaling to be received and the specific PDCCH) of the listed items, if a downlink channel is the downlink physical channel configured by higher layer signaling to be received or the specific PDCCH, the downlink channel satisfies Predefined Condition 1, otherwise (that is, if the downlink channel is neither the downlink physical channel configured by higher layer signaling to be received nor the specific PDCCH), the downlink channel does not satisfy Predefined Condition 1 (is not associated with Predefined Condition 1). The manners described above are also applicable to various predefined conditions to be described later.

In some implementations, Predefined Condition 2 may include at least one of:
a SR. For example, when the UE is configured and/or indicated to be in a specific mode, the UE may transmit SRs, or the UE may transmit a specific SR. The specific SR may be a SR with the higher priority. The specific SR may be a SR configured and/or indicated by higher layer signaling (for example, configured in a 3GPP parameter SchedulingRequestResourceConfig and/or LogicalChannelConfig) that it could be transmitted in the specific mode (e.g., mode 2). This can reduce the blind detection of the SR by the base station, and ensure that the transmission delay of services with the higher priority is not affected while reducing the power consumption of the base station.
a CG PUSCH. For example, when the UE is configured and/or indicated to be in a specific mode, the UE may transmit CG PUSCHs, or the UE may transmit a specific CG PUSCH. The specific CG PUSCH may be a CG PUSCH with the higher priority. The specific CG PUSCH may be a CG PUSCH configured and/or indicated by higher layer signaling (for example, configured in a 3GPP parameter ConfiguredGrantConfig and/or LogicalChannelConfig) that it can be transmitted in the specific mode (e.g., mode 2). This can reduce the blind detection of the CG PUSCH by the base station, and ensure that the transmission delay of services with the higher priority is not affected while reducing the power consumption of the base station.
a PUSCH scheduled by a DCI format.
a PUSCH with aperiodic CSI (ACSI).
a PUCCH and/or PUSCH with HARQ-ACK. For example, the PUCCH and/or PUSCH with HARQ-ACK may be all PUCCHs and/or PUSCHs with HARQ-ACK. Or, the PUCCH and/or PUSCH with HARQ-ACK may be a PUCCH and/or PUSCH with HARQ-ACK with the higher priority.
a PRACH.

The method can improve the accuracy and flexibility of network energy saving.

### Manner MN11

In some implementations, a condition for transmitting the predefined uplink signaling may be specified by protocols and/or configured by higher layer signaling, for example, the condition for transmitting the predefined uplink signaling may be Predefined Condition 5. Predefined Condition 5 may be at least one of the following:
the current mode (e.g., a mode when transmitting the predefined uplink signaling) is the second mode.
All the time domain resources of the predefined uplink signaling are in the second mode.
a first timer associated with the predefined uplink signaling is not running. For example, after the UE transmits the predefined uplink signaling, the first timer may be started. If the first timer expires (or is not running), the UE may transmit the predefined uplink signaling. It may also be specified by protocols and/or configured by higher layer signaling that, if the UE receives a specific DCI format (e.g., a DCI format that explicitly or implicitly indicates mode switching (the change from the second mode (e.g., mode 2) to the first mode (e.g., mode 1)), the UE stops running the first timer. The method can avoid frequently transmitting the predefined uplink signaling and reduce the power consumption of the UE.
a MAC layer triggers a SR. It may be further specified that the SR may be a specific SR, for example, a SR with the higher priority; for another example, a SR corresponding to a specific logical channel priority.
the MAC layer triggers a predefined indication (or an indication predefined by the MAC layer is a pending state). For example, the predefined indication may be a base station wakeup indication. For another example, the predefined indication may be an indication of the mode change.

By limiting the transmission of the uplink channel, the UE transmission power can be reduced, and at the same time, the blind detection of the base station can be reduced, and thus the power consumption of the base station can be reduced.

### Manner MN12

In some implementations, the change/switching of different modes may be implemented by BWP switching. For example, the modes (e.g., the operating mode of the UE) in embodiments of the disclosure may be associated with the BWP. For example, a corresponding mode may be configured in BWP configuration parameters (e.g., 3GPP parameter BWP-DownlinkDedicated, BWP-UplinkDedicated). For example, a BWP may be configured as the energy-saving mode. In embodiments of the disclosure, the method of receiving and/or transmitting channels by the UE in each mode may also be the corresponding method of receiving and/or transmitting channels by the UE in the BWP. For example, the UE switching to the energy-saving mode may be equivalent to the UE switching to the BWP configured with the energy-saving mode. In embodiments of the disclosure, the method of mode change may also be the corresponding method of BWP switching.

The method can indicate the UE to operate in a specific BWP in the network energy-saving state by BWP switching, where the BWP may be a BWP with a smaller bandwidth, so that the frequency domain range of the base station can be reduced, thereby saving the energy consumption of the base station.

It should be noted that, the embodiments of the disclosure may be applicable to a scenario where network energy-saving parameters are configured. For example, when the UE is configured with cell DTX and/or cell DRX parameters, the serving cell may receive and/or transmit data and/or control information using the methods specified in embodiments of the disclosure.

It should be noted that, in embodiments of the disclosure, the predefined DCI format may also be at least one of DCI formats 1_2, 11, 0_2 and 0_1. The predefined DCI format may also be a multicast or broadcast DCI format.

It should be noted that, the methods defined in embodiments of the disclosure may be applicable to a serving cell; it may also be applicable to a specific frequency domain resource of a serving cell, e.g., a BWP; and it may further be applicable to one or more specific channels.

It should be noted that, while the above embodiments define the modes (e.g., energy-saving mode) related to the operations or behaviors of the base station or the UE and are described based on the modes, the embodiments of the disclosure are not limited to thereto. For example, the modes (e.g., energy-saving mode) related to the operations or behaviors of the base station or the UE may not be defined by protocols, and the UE may be configured with a certain parameter, for example, corresponding to the modes. Therefore, the methods applicable to the energy-saving mode (or specific mode) in embodiments of the disclosure may also be used in the scenario where the UE is configured with a predefined parameter. In this case, when the UE is configured with the predefined parameter, the base station and/or the UE may know the mode used for communication with each other, and may communicate with each other based on one or more of the manners described above.

FIG. 8 illustrates a flowchart of a method 800 performed by a terminal according to some embodiments of the disclosure.

Referring to FIG. 8, in operation S810, a mode of the terminal and/or a base station is determined.

In operation S820, at least one of transmitting an uplink channel, receiving a downlink channel, not transmitting an uplink channel, or not receiving a downlink channel is performed based on the determined mode.

In some implementations, each of operation S810 or operation S820 may be performed based on one or more of the manners described above (e.g., manner MN1-manner MN10).

FIG. 9 illustrates a block diagram of a first transceiving node 900 according to the embodiments of the disclosure.

Referring to FIG. 9, the first transceiving node 900 may include a transceiver 901 and a controller 902.

The transceiver 901 may be configured to transmit first data and/or first control signaling to a second transceiving node and receive second data and/or second control signaling from the second transceiving node in a time unit.

The controller 902 may be an application specific integrated circuit or at least one processor. The controller 902 may be configured to control the overall operation of the first transceiving node, including controlling the transceiver 901 to transmit the first data and/or the first control signaling to the second transceiving node and receive the second data and/or the second control signaling from the second transceiving node in a time unit.

In some implementations, the controller 902 may be configured to perform one or more of operations in the methods of various embodiments described above and the methods of the embodiments described below.

In the following description, a base station is taken as an example (but not limited thereto) to illustrate the first transceiving node, a UE is taken as an example (but not limited thereto) to illustrate the second transceiving node. Downlink data and/or downlink control signaling (but not limited thereto) are used to illustrate the first data and/or the first control signaling. A HARQ-ACK codebook may be included in the second control signaling, and uplink control signaling (but not limited thereto) is used to illustrate the second control signaling.

FIG. 10 illustrates a flowchart of a method 1000 performed by a base station according to an embodiment of the disclosure.

Referring to FIG. 10, in step S1010, the base station transmits downlink data and/or downlink control information.

In step S1020, the base station receives second data and/or second control information from a UE in a time unit.

For example, the method 1000 may include one or more of the operations performed by the base station that are described in various embodiments of the disclosure.

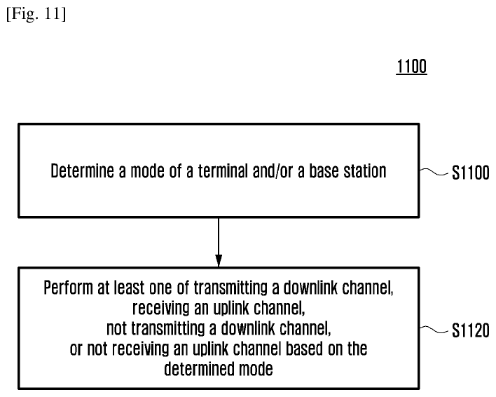

FIG. 11 illustrates a flowchart of a method 1100 performed by a base station according to some embodiments of the disclosure.

Referring to FIG. 11, in operation S1110, a mode of a terminal and/or the base station is determined.

In operation S1120, at least one of transmitting a downlink channel, receiving an uplink channel, not transmitting a downlink channel, or not receiving an uplink channel is performed based on the determined mode.

In some implementations, each of operation S1110 or operation S1120 may be performed based on one or more of the manners described above (e.g., manner MN1-manner MN10).

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the disclosure, and is not intended to limit the scope of protection of the disclosure, which is determined by the appended claims.

1-15. (canceled)

16. A method performed by a user equipment (UE) in a communication system, the method comprising:
receiving, via higher layer signaling, a configuration associated with an energy-saving mode;
receiving a downlink control information (DCI) format including an indication for a serving cell; and
determining, based on the indication, whether the energy saving mode is used for the serving cell,
wherein the energy-saving mode corresponds to at least one of a cell discontinuous transmission (DTX) or a cell discontinuous reception (DRX).

17. The method of claim 16, wherein the DCI format includes a plurality of indications for a plurality of serving cells,
wherein each indication corresponds to 1 bit,
wherein a first value for the 1 bit indicates that the energy-saving mode is used for a corresponding serving cell, and
wherein a second value for the 1 bit indicates that the energy-saving mode is not used for the corresponding serving cell.

18. The method of claim 16, The method of claim 16, further comprising transmitting a UE capability indicating whether at least one of the cell DTX or the cell DRX is supported by the UE.

19. The method of claim 16, wherein the cell DTX is associated with predefined downlink signals that are not received in an inactive state for the cell DTX identified based on the configuration associated with the energy-saving mode,
wherein the cell DRX is associated with predefined uplink signals that are not transmitted in an inactive state for the cell DRX identified based on the configuration associated with the energy-saving mode, and
wherein the predefined uplink signals include a scheduling request (SR) and a configured grant (CG) physical uplink shared channel (PUSCH).

20. The method of claim 16, wherein a cyclic redundancy check (CRC) for the DCI format is scrambled by a radio network temporary identifier (RNTI) for energy-saving,
wherein in case of identifying that a current operation mode for the serving cell is changed based on the determining, a changed operation mode for the serving cell is applied at a predefined time after the DCI format is received, and
wherein the current operation mode and the changed operation mode are (i) the energy-saving mode and a non-energy-saving mode, respectively, or (ii) the non-energy-saving mode and the energy-saving mode, respectively.

21. A user equipment (UE) in a communication system, the UE comprising:
a transceiver; and
a processor coupled with the transceiver and configured to:
receive, via higher layer signaling, a configuration associated with an energy-saving mode,
receive a downlink control information (DCI) format including an indication for a serving cell, and
determine, based on the indication, whether the energy-saving mode is used for the serving cell,
wherein the energy-saving mode corresponds to at least one of a cell discontinuous transmission (DTX) or a cell discontinuous reception (DRX).

22. The UE of claim 21, wherein the DCI format includes a plurality of indications for a plurality of serving cells,
wherein each indication corresponds to 1 bit,
wherein a first value for the 1 bit indicates that the energy-saving mode is used for a corresponding serving cell, and
wherein a second value for the 1 bit indicates that the energy-saving mode is not used for the corresponding serving cell.

23. The UE of claim 21, wherein the processor is further configured to transmit a UE capability indicating whether at least one of the cell DTX or the cell DRX is supported by the UE.

24. The UE of claim 21, wherein the cell DTX is associated with predefined downlink signals that are not received in an inactive state for the cell DTX identified based on the configuration associated with the energy-saving mode,
wherein the cell DRX is associated with predefined uplink signals that are not transmitted in an inactive state for the cell DRX identified based on the configuration associated with the energy-saving mode, and
wherein the predefined uplink signals include a scheduling request (SR) and a configured grant (CG) physical uplink shared channel (PUSCH).

25. The UE of claim 21, wherein a cyclic redundancy check (CRC) for the DCI format is scrambled by a radio network temporary identifier (RNTI) for energy-saving,
wherein in case of identifying that a current operation mode for the serving cell is changed based on the determination, a changed operation mode for the serving cell is applied at a predefined time after the DCI format is received, and
wherein the current operation mode and the changed operation mode are (i) the energy-saving mode and a non-energy-saving mode, respectively, or (ii) the non-energy-saving mode and the energy-saving mode, respectively.

26. A method performed by a base station in a communication system, the method comprising:
transmitting, to a user equipment (UE), via higher layer signaling, a configuration associated with an energy-saving mode;
determining whether the energy-saving mode is to be used for a serving cell; and
transmitting, to the UE, based on the determining, a downlink control information (DCI) format including an indication for the serving cell,
wherein the energy-saving mode corresponds to at least one of a cell discontinuous transmission (DTX) or a cell discontinuous reception (DRX).

27. The method of claim 26, wherein the DCI format includes a plurality of indications for a plurality of serving cells,
wherein each indication corresponds to 1 bit,
wherein a first value for the 1 bit indicates that the energy-saving mode is to be used for a corresponding serving cell, and
wherein a second value for the 1 bit indicates that the energy-saving mode is not to be used for the corresponding serving cell.

28. The method of claim 26, further comprising receiving, from the UE, a UE capability indicating whether at least one of the cell DTX or the cell DRX is supported by the UE.

29. The method of claim 26, wherein the cell DTX is associated with predefined downlink signals that are not received in an inactive state for the cell DTX identified based on the configuration associated with the energy-saving mode,
wherein the cell DRX is associated with predefined uplink signals that are not transmitted in an inactive state for the cell DRX identified based on the configuration associated with the energy-saving mode, and
wherein the predefined uplink signals include a scheduling request (SR) and a configured grant (CG) physical uplink shared channel (PUSCH).

30. The method of claim 26, wherein a cyclic redundancy check (CRC) for the DCI format is scrambled by a radio network temporary identifier (RNTI) for energy-saving,
wherein in case of indicating that a current operation mode for the serving cell is changed based on the DCI format, a changed operation mode for the serving cell is applied at a predefined time after the DCI format is received, and
wherein the current operation mode and the changed operation mode are (i) the energy-saving mode and a non-energy-saving mode, respectively, or (ii) the non-energy-saving mode and the energy-saving mode, respectively.

31. A base station in a communication system, the base station comprising:
a transceiver; and
a processor coupled with the transceiver and configured to:
transmit, to a user equipment (UE), via higher layer signaling, a configuration associated with an energy-saving mode,
determine whether the energy-saving mode is to be used for a serving cell, and
transmit, to the UE, based on the determination, a downlink control information (DCI) format including an indication for the serving cell, and
wherein the energy-saving mode corresponds to at least one of a cell discontinuous transmission (DTX) or a cell discontinuous reception (DRX).

32. The base station of claim 31, wherein the DCI format includes a plurality of indications for a plurality of serving cells,
wherein each indication corresponds to 1 bit,
wherein a first value for the 1 bit indicates that the energy-saving mode is to be used for a corresponding serving cell, and
wherein a second value for the 1 bit indicates that the energy-saving mode is not to be used for the corresponding serving cell.

33. The base station of claim 31, wherein the processor is further configured to receive, from the UE, a UE capability indicating whether at least one of the cell DTX or the cell DRX is supported by the UE.

34. The base station of claim 31, wherein the cell DTX is associated with predefined downlink signals that are not received in an inactive state for the cell DTX identified based on the configuration associated with the energy-saving mode,
wherein the cell DRX is associated with predefined uplink signals that are not transmitted in an inactive state for the cell DRX identified based on the configuration associated with the energy-saving mode, and
wherein the predefined uplink signals include a scheduling request (SR) and a configured grant (CG) physical uplink shared channel (PUSCH).

35. The base station of claim 31, wherein a cyclic redundancy check (CRC) for the DCI format is scrambled by a radio network temporary identifier (RNTI) for energy-saving,
wherein in case of indicating that a current operation mode for the serving cell is changed based on the DCI format, a changed operation mode for the serving cell is applied at a predefined time after the DCI format is received, and
wherein the current operation mode and the changed operation mode are (i) the energy-saving mode and a non-energy-saving mode, respectively, or (ii) the non-energy-saving mode and the energy-saving mode, respectively.
